(19) United States
(12) Patent Application Publication
(10) Pub. No.: US 2010/0129522 A1
(43) Pub. Date: May 27, 2010

(54) CAFFEINATED FROZEN CONFECTIONS

(76) Inventor: Jonathan Morse, Rochester, NY (US)

Correspondence Address: HISCOCK & BARCLAY, LLP, 2000 HSBC PLAZA, 100 Chestnut Street, ROCHESTER, NY, 14604-2404, US

(21) Appl. No.: 12/276,661

(22) Filed: Nov. 24, 2008

(51) Int. Cl. A23G 3/36

(52) U.S. Cl. 426/660

(57) ABSTRACT

The present invention is related to a caffeinated freeze pop product. Specifically, the mixture for the freeze pop includes water, sweetener, preservatives, caffeine, citric acid, flavoring agent, and a coloring agent. The sweetener can be any type of sweetener but is preferably high fructose corn syrup, and the preservatives generally are sodium benzoate, potassium sorbate, and adenosine monophosphate. The flavoring agent can be of any flavor, and include: cherry, orange, blue raspberry, tropical fruit, sour apple, and wild berry. Further the color of the caffeinated freeze pops can be any color, including: red, orange, blue, purple, yellow, and green. Generally the method of making the freeze pop is to dissolve the preservatives into the water; then combining in the citric acid, caffeine, and sweetener; and last combining the caffeinated mixture with flavoring and coloring agents for visual and taste appeal.

### FIELD OF THE INVENTION

The subject of the invention is caffeinated frozen confectionary products.

### BACKGROUND OF THE INVENTION

Caffeine is a known crystalline compound. It comes in varying chemical forms and it is a stimulant for the central nervous system in humans. Because of its stimulating properties, caffeine has been a long-standing source of quick energy for consumers.

Caffeine occurs naturally in many plants and seeds, such as coffee and cocoa beans and tea leaves. Therefore, historical forms of introducing caffeine into one's system was through chewing on seeds, bark, or leaves of caffeinated plants. Thereafter, more traditional forms of ingesting caffeine were through drinking the extracts of tea leaves or coffee beans boiled in water or other liquids.

In the early 19^{th} century, caffeine was then introduced in soft drinks using caffeine derived from kola nut. With the invention of modern technology and ability to easily manufacture chemical compounds, caffeine, in its varying forms, have been introduced to different drinks for providing energy.

In addition to drinks, caffeine is found in some food products, either as a natural occurrence in the products. For instance, chocolate, coffee bean, seeds, various candies, and mints have all been found to have caffeine because of the product itself (e.g. seeds and coffee beans) or its ingredients (e.g. cocoa) have naturally occurring caffeine.

More recently, there are products on the market where caffeine has been added to chewing gum or even in straight ingestible format. For instance, U.S. Pat. No. 6,024,988, entitled, “Caffeine Chewing Gum,” to Ronald Ream, et al., issued on Feb. 15, 2000 discloses an improved chewing gum composition including caffeine. Further, U.S. Pat. No. 6,444,241, entitled, “Caffeine coated chewing gum product and process of making,” issued to Henry Tyrpin on Sep. 3, 2002 discloses a chewing gum with a controlled release of caffeine. However, there is a need in the art for other products having caffeine.

Therefore, it is desired in the art to have food products having caffeine, such as frozen confections.

### SUMMARY OF THE INVENTION

The invention comprises, in one form thereof, a caffeinated frozen confection mixture comprising water, sweetener, citric acid, preservatives, and caffeine.

More particularly, the invention includes a caffeinated frozen confection mixture comprising by percent weight: at least 71% water, at least 27% sweetener, at least 0.63% citric acid, at least 0.025% sodium benzoate, at least 0.025% potassium sorbate, at least 0.05% adenosine monophosphate, at least 0.126% caffeine, at least 0.10% weight of a flavoring agent and 0.02% weight of a coloring agent.

In another form, the invention includes a method for making a caffeinated frozen confection mixture comprising the steps of: providing water, preservatives, citric acid, sweetener, caffeine, flavoring agent, and a coloring agent; mixing water with the preservatives until preservatives are dissolved; adding citric acid, sweetener, and caffeine until completely combined; and adding flavoring and coloring agents until completely combined.

An advantage of the present invention is that it provides a source of energy, via caffeine, in a form other than liquid or in a candy product.

### DETAILED DESCRIPTION

The present invention is directed to a caffeinated frozen confection and method for making same. The present invention is described as freeze pop, however, it will be well understood by those in the art that it could be substituted for any frozen confectionary product. The caffeinated frozen confection can be made in varying flavors and amounts of caffeine, but is disclosed below in a preferred embodiment.

Pursuant to the present invention, caffeine is used in an anhydrous form (1,3,7,-Trimethylxanthinemonohydrate), though those in the art will recognize other forms of caffeine can be used with the following formulation. In the invention, caffeine will comprise at least about 0.1%, by weight of the freeze pop, and can deliver between 85mg to 150 mg of caffeine per freezer pop. Preferably, caffeine will comprise about 0.126% by weight of the freeze pop, delivering about 120 mg of caffeine per freezer pop. Though the preferred embodiment uses caffeine, other forms of energy-boosting compounds maybe substituted, such as guarana, taurine, ginseng, and other energy compounds.

Referring now to the caffeinated freeze pops, the popsicles having caffeine may be based on a variety of different types already known in the art. For example, the freezer pops can be in varying degrees of calories, fat, and sugar (i.e. high, low, or free) and further may contain other ingredients or novelties in addition the basic formula disclosed below.

The freeze pops generally consist of water, sweetener (e.g. high-fructose corn syrup), citric acid, sodium benzoate, potassium sorbate, adenosine monophosphate (i.e. bitter blocker), caffeine, and then varying levels of flavoring and coloring to achieve taste and visual appeal.

Typically, the water content is at least 50% by weight, but preferably is about 70%. More particularly, the water content is in a range from 71.76% to 71.92% by weight of the freezer pop.

Though the preferred embodiment discloses high frctose corn syrup, it will be recognized by those skilled in the art that varying types of sweeteners may be used to adjust for fat and caloric intake. The sweetener typically constitute about 20% by weight of the freeze pop, more typically about 27% by weight of the freeze pop. Sugar sweeteners generally include: sucrose, dextrose, maltose, dextrin, dried invert sugar, fructose, levulose, glactose, corn syrups, and the like. Sugarless sweeteners include: sorbitol, mannitol, xylitol, hydrogenated starch hydrolysates, maltitol, and the like. Still other types of sweeteners may include artificial sweeteners such as: sucralose, aspartame, salts of acesulfame, altitame, saccharin and its salts, cyclamic acid and its salts, glycerrhizinate, dihydrochalcones, thaumatin, monellin, and the like.

The remaining ingredients can be provided in varying degrees, but preferably are in the following form and percent weight:

| Ingredient | Percent Weight |
|---|---|
| Citric Acid | 00.63% |
| Sodium Benzoate | 00.25% |
| Potassium Sorbate | 00.25% |
| Adenosine Monophosphate | 00.05% |
| Caffeine (Anhydrous) | 0.126% |

A variety of flavoring and coloring agents maybe used to provide visual and taste appeal. Generally the flavoring content will range from 0.05% to 0.50%, but will typically range from 0.10% to 0.30% by weight of the freezer pop. The flavoring agents can include orange, cherry, raspberry, tropical, sour apple, mixed berry. Other fruit, candy, mint, or similar flavors are possible. The color coloring agents will range from 0.01% to 0.50%, but will typically range from 0.02% to 0.20% by weight of the freeze pop.

Following are a series of examples, by percent weight, of flavored caffeinated freeze pops:

| Flavor | Ingredients by Percent Weight |
|---|---|
| Cherry | Water (71.86%); High Fructose Corn Syrup (27.00%); Citric Acid |
| | (.63%); Sodium Benzoate (.025%); Potassium Sorbate (.025%); |
| | Bitter Block (.05%); Caffeine (.126%); Cherry Flavoring (.20%); |
| | Cherry Color (.06%) |
| Orange | Water (71.92%); High Fructose Corn Syrup (27.00%); Citric Acid |
| | (.63%); Sodium Benzoate (.025%); Potassium Sorbate (.025%); |
| | Bitter Block (.05%); Caffeine (.126%); Orange Flavoring (.12%); |
| | Orange Color (.08%) |
| Blue Raspberry | Water (71.90%); High Fructose Corn Syrup (27.00%); Citric Acid |
| | (.63%); Sodium Benzoate (.025%); Potassium Sorbate (.025%); |
| | Bitter Block (.05%); Caffeine (.126%); Raspberry Flavoring (.20%); |
| | Blue Color (.02%) |
| Wild Berry | Water (71.84%); High Fructose Corn Syrup (27.00%); Citric Acid |
| | (.63%); Sodium Benzoate (.025%); Potassium Sorbate (.025%); |
| | Bitter Block (.05%); Caffeine (.126%); Mixed Berry Flavoring |
| | (.24%); Purple Color (.04%) |
| Tropical Fruit | Water (71.82%); High Fructose Corn Syrup (27.00%); Citric Acid |
| | (.63%); Sodium Benzoate (.025%); Potassium Sorbate (.025%); |
| | Bitter Block (.05%); Caffeine (.126%); Tropical Fruit Flavoring |
| | (.24%); Yellow Color (.06%) |
| Sour Apple | Water (71.76%); High Fructose Corn Syrup (27.00%); Citric Acid |
| | (.63%); Sodium Benzoate (.025%); Potassium Sorbate (.025%); |
| | Bitter Block (.05%); Caffeine (.126%); Sour Apple Flavoring (.20%); |
| | Lime Green Color (.16%) |

Further, the freeze pop mix is made to have proper degrees Brix (° Bx), pH balance, and percent of total acidity (% TA) for quality control purposes. The freeze pop mix should range in 18.5° Bx to 19.7° Bx, with the target being 19.1° Bx. The pH is generally within the range of 2.55 to 2.95, but ideally is 2.75 pH. Last, the percent of total acidity should range from 0.295 to 0.335, but ideally is 0.315.

One, but not the only, method for making the freeze pops, is to mix the preservatives with the water until the preservatives are dissolved. Thereafter, the sweetener, caffeine, and citric acid are added until combined. Last the flavoring and coloring agents are added to the mix until completely combined.

As a preferred method, sodium benzoate, bitter block, and potassium sorbate are all added to the water and mixed until they are dissolved. Then, the high fructose corn syrup, caffeine (anhydrous), and citric acid are mixed in until the products are completely combined. The last components are the flavoring and color components. To ensure the products are at a given quality, the pH should then be measured along with the degrees Brix and total acid measurements to see if they fall within the above-specified ranges. Once the mix is determined to be of suitable quality, they may be individual frozen or packaged and then frozen, as may be desired.

While the invention has been described with reference to particular embodiments, it will be understood by those skilled in the art that various changes may be made and equivalents may be substituted for elements thereof without departing from the scope of the invention. In addition, many modifications may be made to adapt a particular situation or material to the teachings of the invention without departing from the scope of the invention.

Therefore, it is intended that the invention not be limited to the particular embodiments disclosed as the best mode contemplated for carrying out this invention, but that the invention will include all embodiments falling within the scope and spirit of the appended claims.

1. A caffeinated frozen confection mixture comprising water, sweetener, citric acid, preservatives, and caffeine.

2. The caffeinated frozen confection mixture of claim 1 further comprising a flavoring agent.

3. The caffeinated frozen confection mixture of claim 2 wherein the flavoring agent is a flavor selected from the group consisting of orange flavoring, cherry flavoring, raspberry flavoring, tropical fruit flavoring, sour apple flavoring, and mixed berry.

4. The caffeinated frozen confection mixture of claim 1 further comprising a coloring agent.

5. The caffeinated frozen confection mixture of claim 4 wherein the coloring agent is a color selected from the group consisting of orange, red, blue, yellow, green, and purple.

6. The caffeinated frozen confection mixture of claim 1 wherein the sweetener is selected from the group consisting of sucrose, dextrose, maltose, dextrin, dried invert sugar, fructose, levulose, glactose, corn syrup, sorbitol, mannitol, xylitol, hydrogenated starch hydrolysates, maltitol, sucralose, aspartame, salts of acesulfame, altitame, saccharin and its salts, cyclamic acid, glycerrhizinate, dihydrochalcones, thaumatin, monellin.

7. The caffeinated frozen confection mixture of claim 1, wherein the preservatives is selected from the group consisting of sodium benzoate, potassium sorbate, and adenosine monophosphate.

8. The caffeinated frozen confection mixture of claim 1, wherein the percentage weight of the ingredients are: at least 70% water, at least 25% sweetener, at least 0.50% citric acid, at least 0.020% sodium benzoate, at least 0.020% potassium sorbate, at least 0.05% adenosine monophosphate, at least 0.1% caffeine.

9. The caffeinated frozen confection mixture of claim 8, farther comprising at least 0.10% weight of a flavoring agent and 0.01% weight of a coloring agent.

10. The caffeinated frozen confection nuxture of claim 1, wherein the freeze pop mixture is three (3) ounces and provides 120 milligrams of caffeine.

11. The caffeinated frozen confection mixture of claim 1, wherein the pH level is in the range of 2 to 3.

12. The caffeinated frozen confection mixture of claim 1, wherein the caffeine is substituted for an energy boosting compound selected from the group consisting of guarana, taurine, or ginseng.

13. A caffeinated frozen confection mixture comprising by percent weight: at least 71% water, at least 27% sweetener, at least 0.63% citric acid, at least 0.025% sodium benzoate, at least 0.025% potassium sorbate, at least 0.05% adenosine monophosphate, at least 0.126% caffeine, at least 0.10% weight of a flavoring agent and 0.02% weight of a coloring agent.

14. A method for making a caffeinated frozen confection mixture comprising the steps of:
a. Providing water, preservatives, citric acid, sweetener, caffeine, flavoring agent, and a coloring agent;
b. Mixing water with the preservatives until preservatives are dissolved;
c. Adding citric acid, sweetener, and caffeine until completely combined; and
d. Adding flavoring and coloring agents until completely combined.

15. The method of claim 14 further comprising the step of packaging the mixture in an unfrozen state.

16. The method of claim 14 further comprising the step of freezing the mixture.

17. The method of claim 14 wherein the sweetener is high fructose corn syrup.

18. The method of claim 14 wherein the preservatives are selected from the group consisting of sodium benzoate, potassium sorbate, and adenosine monophosphate.

19. The method of claim 14 wherein the flavoring agent is a flavor selected from the group consisting of orange flavoring, cherry flavoring, raspberry flavoring, tropical fruit flavoring, sour apple flavoring, and mixed berry.

20. The method of claim 14 wherein the coloring agent is a color selected from the group consisting of orange, red, blue, yellow, green, and purple.
